(19) United States
(12) Patent Application Publication
(10) Pub. No.: US 2025/0355649 A1
(43) Pub. Date: Nov. 20, 2025

(54) APPLICATION OF ARTIFICIAL INTELLIGENCE FOR INTERACTION WITH EXPERT SOFTWARE APPLICATIONS

(71) Applicant: Epicor Software Corporation, Austin, TX (US)

(72) Inventors: Arturo P. Buzzalino, Madison, AL (US); Aieat Assam, Halesowen (GB); Luigi Ottoboni, Fidenza (IT); Brian A. Conner, San Diego, CA (US)

(21) Appl. No.: 19/202,576

(22) Filed: May 8, 2025

Related U.S. Application Data
(60) Provisional application No. 63/648,863, filed on May 17, 2024.

(51) Int. Cl. G06F 8/41; G06F 8/33; G06F 8/72

(52) U.S. Cl. CPC G06F 8/427; G06F 8/33; G06F 8/72

(57) ABSTRACT

Embodiments of the present disclosure are directed to facilitating access and use of existing domain expert software applications through the use of Artificial Intelligence (AI) to analyze, distill and index source code of expert software systems and expose information through new and evolving fully dynamic natural language interfaces. More specifically, embodiments described herein are directed to dynamically building an interface to existing expert systems through recursive summarization of expert system logic (potentially decades of it) into condensed AI-generated summaries from the unlabeled source code. These summaries, describing the different parts of the expert system, can then be used to generate new means of interacting with the existing system without having to fully understand or write the interface.

### CROSS REFERENCE TO RELATED APPLICATION

The present application claims the benefits of and priority, under 35 U.S.C. § 119 (e), to U.S. Provisional Application No. 63/648,863 filed May 17, 2024 by Buzzalino, et. al. and entitled “Application of Artificial Intelligence for Interaction with Expert Software Applications” of which the entire disclosure is incorporated herein by reference for all purposes.

### FIELD OF THE DISCLOSURE

Embodiments of the present disclosure relate generally to methods and systems for developing and executing software applications and more particularly to facilitating access and use of existing domain expert software applications through the use of Artificial Intelligence (AI).

### BACKGROUND

Traditional domain expert software applications when evolved over long periods of time contain domain specific knowledge and expertise distilled into their source code. Accessing and interfacing with this expertise requires extensive UI and training. Each usage pattern and workflow has to be manually configured and evolution of new paradigms despite being possible by underlaying expertise cannot be accessed without access surface modification, e.g., U ser Interface (UI) and Application Programming Interface (API) changes.

### BRIEF SUMMARY

Embodiments of the disclosure provide systems and methods for facilitating access and use of existing domain expert software applications through the use of Artificial Intelligence (AI) to analyze, distill and index source code of expert software systems and expose information through new and evolving fully dynamic natural language interfaces. According to one embodiment, a method for developing and executing software applications can comprise reading source code of an expert system application and analyzing the source code using a generative Artificial Intelligence (AI). The generative AI can comprise a Large Language Model (LLM). Results of the analyzing of the read source code can comprise a set of annotated component descriptions of components and subcomponents of expert system application. A selected set of the components and subcomponents of the expert system application can be executed based on a query regarding the expert system application and the set of annotated component descriptions of components and subcomponents of expert system application.

Analyzing the source code can comprise dividing the source code of the components and subcomponents of the expert system application into a set of overlapping chunks, summarizing each chunk of the set of overlapping chunks into a pseudocode summary using the generative AI, reassembling the set of overlapping chunks into a reduced set of code, and determining whether a predefined size set of summaries is available. In response to determining the predefined size set of summaries is not yet available, the process can iterate the dividing the source code of the components and subcomponents of the expert system application into the set of overlapping chunks, summarizing each chunk of the set of overlapping chunks into a pseudocode summary using the generative AI, reassembling the set of overlapping chunks into a reduced set of code, and determining whether a predefined size set of summaries is available until a determination is made that the predefined size set of summaries is available. In response to determining the predefined size set of summaries is available an annotated component description for each component and subcomponent of the expert system application can be generated based on the set of summaries using the generative AI and the annotated component description for each component and subcomponent of the expert system application can be saved.

Executing the selected set of the components and subcomponents of the expert system application can comprise receiving the query regarding the expert system application. The query regarding the expert system application can comprise a natural language text prompt or a natural language voice prompt. Executing the selected set of the components and subcomponents of the expert system application can further comprise generating a subcomponent execution plan based on the received query and the saved annotated component descriptions using the generative AI, executing one or more components or subcomponents of the expert system application based on the generated subcomponent execution plan, summarizing results of executing the one or more components or subcomponents of the expert system application using the generative AI, and presenting the summarized results of executing the one or more components or subcomponents of the expert system application.

According to another embodiment, a system can comprise a processor and a memory coupled with and readable by the processor, the memory can store therein a set of instructions which, when executed by the processor, causes the processor to read source code of an expert system application and analyze the source code using a generative AI. The generative AI can comprise a LLM. Results of the analyzing of the read source code can comprise a set of annotated component descriptions of components and subcomponents of expert system application. The instructions can further cause the processor to execute a selected set of the components and subcomponents of the expert system application based on a query regarding the expert system application and the set of annotated component descriptions of components and subcomponents of expert system application.

Analyzing the source code can comprise dividing the source code of the components and subcomponents of the expert system application into a set of overlapping chunks, summarizing each chunk of the set of overlapping chunks into a pseudocode summary using the generative AI, reassembling the set of overlapping chunks into a reduced set of code, and determining whether a predefined size set of summaries is available. In response to determining the predefined size set of summaries is not yet available, the instructions can further cause the processor to iterate the dividing the source code of the components and subcomponents of the expert system application into the set of overlapping chunks, summarizing each chunk of the set of overlapping chunks into a pseudocode summary using the generative AI, reassembling the set of overlapping chunks into a reduced set of code, and determining whether a predefined size set of summaries is available until a determination is made that the predefined size set of summaries is available. In response to determining the predefined size set of summaries is available, the instructions can further cause the processor to generate and save an annotated component description for each component and subcomponent of the expert system application based on the set of summaries using the generative AI.

Executing the selected set of the components and subcomponents of the expert system application can comprise receiving the query regarding the expert system application. The query regarding the expert system application can comprise a natural language text prompt or a natural language voice prompt. The instructions can further cause the processor to generate a subcomponent execution plan based on the received query and the saved annotated component descriptions using the generative AI, execute one or more components or subcomponents of the expert system application based on the generated subcomponent execution plan, summarize results of executing the one or more components or subcomponents of the expert system application using the generative AI, and present the summarized results of executing the one or more components or subcomponents of the expert system application.

According to yet another embodiment, a non-transitory, computer-readable medium can comprise a set of instructions stored therein which, when executed by a processor, causes the processor to read source code of an expert system application and analyze the source code using a generative AI. The generative AI can comprise a LLM. Results of the analyzing of the read source code can comprise a set of annotated component descriptions of components and subcomponents of expert system application. The instructions can further cause the processor to execute a selected set of the components and subcomponents of the expert system application based on a query regarding the expert system application and the set of annotated component descriptions of components and subcomponents of expert system application.

Analyzing the source code can comprise dividing the source code of the components and subcomponents of the expert system application into a set of overlapping chunks, summarizing each chunk of the set of overlapping chunks into a pseudocode summary using the generative AI, reassembling the set of overlapping chunks into a reduced set of code, and determining whether a predefined size set of summaries is available. In response to determining the predefined size set of summaries is not yet available, the instructions can further cause the processor to iterate the dividing the source code of the components and subcomponents of the expert system application into the set of overlapping chunks, summarizing each chunk of the set of overlapping chunks into a pseudocode summary using the generative AI, reassembling the set of overlapping chunks into a reduced set of code, and determining whether a predefined size set of summaries is available until a determination is made that the predefined size set of summaries is available. In response to determining the predefined size set of summaries is available, the instructions can further cause the processor to generate and save an annotated component description for each component and subcomponent of the expert system application based on the set of summaries using the generative AI.

Executing the selected set of the components and subcomponents of the expert system application can comprise receiving the query regarding the expert system application. The query regarding the expert system application can comprise a natural language text prompt or a natural language voice prompt. The instructions can further cause the processor to generate a subcomponent execution plan based on the received query and the saved annotated component descriptions using the generative AI, execute one or more components or subcomponents of the expert system application based on the generated subcomponent execution plan, summarize results of executing the one or more components or subcomponents of the expert system application using the generative AI, and present the summarized results of executing the one or more components or subcomponents of the expert system application.

### BRIEF DESCRIPTION OF THE DRAWINGS

FIG. 1 is a block diagram illustrating elements of an exemplary computing environment in which embodiments of the present disclosure may be implemented.

FIG. 2 is a block diagram illustrating elements of an exemplary computing device in which embodiments of the present disclosure may be implemented.

FIG. 3 is a block diagram illustrating an exemplary environment in which embodiments of the present disclosure can be implemented.

FIG. 4 is a diagram conceptually illustrating an analysis phase of applying artificial intelligence for interaction with expert software applications according to one embodiment of the present disclosure.

FIG. 5 is a diagram conceptually illustrating an execution phase of applying artificial intelligence for interaction with expert software applications according to one embodiment of the present disclosure.

FIG. 6 is a flowchart illustrating an exemplary process for applying artificial intelligence for interaction with expert software applications according to one embodiment of the present disclosure.

FIG. 7 is a flowchart illustrating additional details of an exemplary analysis process according to one embodiment of the present disclosure.

FIG. 8 is a flowchart illustrating additional details of an exemplary execution process according to one embodiment of the present disclosure.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

In the following description, for the purposes of explanation, numerous specific details are set forth in order to provide a thorough understanding of various embodiments disclosed herein. It will be apparent, however, to one skilled in the art that various embodiments of the present disclosure may be practiced without some of these specific details. The ensuing description provides exemplary embodiments only and is not intended to limit the scope or applicability of the disclosure. Furthermore, to avoid unnecessarily obscuring the present disclosure, the preceding description omits a number of known structures and devices. This omission is not to be construed as a limitation of the scopes of the claims. Rather, the ensuing description of the exemplary embodiments will provide those skilled in the art with an enabling description for implementing an exemplary embodiment. It should however be appreciated that the present disclosure may be practiced in a variety of ways beyond the specific detail set forth herein.

While the exemplary aspects, embodiments, and/or configurations illustrated herein show the various components of the system collocated, certain components of the system can be located remotely, at distant portions of a distributed network, such as a Local-Area Network (LAN) and/or Wide-Area Network (WAN) such as the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the following description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, Non-Volatile Random-Access Memory (NVRAM), or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a Compact Disk Read-Only Memory (CD-ROM), any other optical medium, punch cards, paper tape, any other physical medium with patterns of holes, a Random-Access Memory (RAM), a Programmable Read-Only Memory (PROM), and Erasable Programable Read-Only Memory (EPROM), a Flash-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

A “computer readable signal” medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, Radio Frequency (RF), etc., or any suitable combination of the foregoing.

The terms “determine,” “calculate,” and “compute,” and variations thereof, as used herein, are used interchangeably and include any type of methodology, process, mathematical operation or technique.

It shall be understood that the term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

In yet another embodiment, the systems and methods of this disclosure can be implemented in conjunction with a special purpose computer, a programmed microprocessor or microcontroller and peripheral integrated circuit element(s), an A SIC or other integrated circuit, a digital signal processor, a hard-wired electronic or logic circuit such as discrete element circuit, a programmable logic device or gate array such as Programmable Logic Device (PLD), Programmable Logic Array (PLA), Field Programmable Gate Array (FPGA), Programmable Array Logic (PAL), special purpose computer, any comparable means, or the like. In general, any device(s) or means capable of implementing the methodology illustrated herein can be used to implement the various aspects of this disclosure. Exemplary hardware that can be used for the disclosed embodiments, configurations, and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A 7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AM D® K averi processors, Texas Instruments® Jacinto C6000™ automotive infotainment processors, Texas Instruments® OMAP™ automotive-grade mobile processors, ARM® Cortex™-M processors, ARM® Cortex-A and ARM 926EJ-S™ processors, other industry-equivalent processors, and may perform computational functions using any known or future-developed standard, instruction set, libraries, and/or architecture.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or Very Large-Scale Integration (VLSI) design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or Common Gateway Interface (CGI) script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

Various additional details of embodiments of the present disclosure will be described below with reference to the figures. While the flowcharts will be discussed and illustrated in relation to a particular sequence of events, it should be appreciated that changes, additions, and omissions to this sequence can occur without materially affecting the operation of the disclosed embodiments, configuration, and aspects.

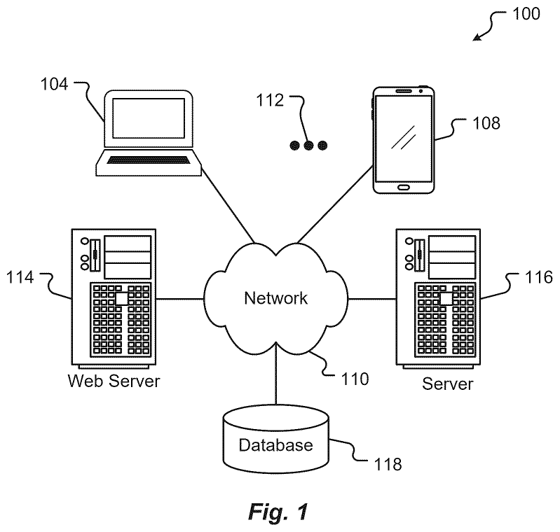

FIG. 1 is a block diagram illustrating elements of an exemplary computing environment in which embodiments of the present disclosure may be implemented. More specifically, this example illustrates a computing environment 100 that may function as the servers, user computers, or other systems provided and described herein. The environment 100 includes one or more user computers, or computing devices, such as a computing device 104, a communication device 108, and/or more 112. The computing devices 104, 108, 112 may include general purpose personal computers (including, merely by way of example, personal computers, and/or laptop computers running various versions of Microsoft Corp.'s Windows® and/or Apple Corp.'s Macintosh® operating systems) and/or workstation computers running any of a variety of commercially-available UNIX® or UNIX-like operating systems. These computing devices 104, 108, 112 may also have any of a variety of applications, including for example, database client and/or server applications, and web browser applications. Alternatively, the computing devices 104, 108, 112 may be any other electronic device, such as a thin-client computer, Internet-enabled mobile telephone, and/or personal digital assistant, capable of communicating via a network 110 and/or displaying and navigating web pages or other types of electronic documents. Although the exemplary computer environment 100 is shown with two computing devices, any number of user computers or computing devices may be supported.

Environment 100 further includes a network 110. The network 110 may can be any type of network familiar to those skilled in the art that can support data communications using any of a variety of commercially-available protocols, including without limitation Session Initiation Protocol (SIP), Transmission Control Protocol/Internet Protocol (TCP/IP), Systems Network Architecture (SNA), Internetwork Packet Exchange (IPX), AppleTalk, and the like. Merely by way of example, the network 110 may be a Local Area Network (LAN), such as an Ethernet network, a Token-Ring network and/or the like; a wide-area network; a virtual network, including without limitation a Virtual Private Network (VPN); the Internet; an intranet; an extranet; a Public Switched Telephone Network (PSTN); an infra-red network; a wireless network (e.g., a network operating under any of the IEEE 802.9 suite of protocols, the Bluetooth® protocol known in the art, and/or any other wireless protocol); and/or any combination of these and/or other networks.

The system may also include one or more servers 114, 116. In this example, server 114 is shown as a web server and server 116 is shown as an application server. The web server 114, which may be used to process requests for web pages or other electronic documents from computing devices 104, 108, 112. The web server 114 can be running an operating system including any of those discussed above, as well as any commercially-available server operating systems. The web server 114 can also run a variety of server applications, including SIP servers, HyperText Transfer Protocol (secure) (HTTP(s)) servers, FTP servers, CGI servers, database servers, Java servers, and the like. In some instances, the web server 114 may publish operations available operations as one or more web services.

The environment 100 may also include one or more file and or/application servers 116, which can, in addition to an operating system, include one or more applications accessible by a client running on one or more of the computing devices 104, 108, 112. The server(s) 116 and/or 114 may be one or more general purpose computers capable of executing programs or scripts in response to the computing devices 104, 108, 112. As one example, the server 116, 114 may execute one or more web applications. The web application may be implemented as one or more scripts or programs written in any programming language, such as Java™, C, C#®, or C++, and/or any scripting language, such as Perl, Python, or Tool Command Language (TCL), as well as combinations of any programming/scripting languages. The application server(s) 116 may also include database servers, including without limitation those commercially available from Oracle®, Microsoft®, Sybase®, IBM® and the like, which can process requests from database clients running on a computing device 104, 108, 112.

The web pages created by the server 114 and/or 116 may be forwarded to a computing device 104, 108, 112 via a web (file) server 114, 116. Similarly, the web server 114 may be able to receive web page requests, web services invocations, and/or input data from a computing device 104, 108, 112 (e.g., a user computer, etc.) and can forward the web page requests and/or input data to the web (application) server 116. In further embodiments, the server 116 may function as a file server. Although for ease of description, FIG. 1 illustrates a separate web server 114 and file/application server 116, those skilled in the art will recognize that the functions described with respect to servers 114, 116 may be performed by a single server and/or a plurality of specialized servers, depending on implementation-specific needs and parameters. The computer systems 104, 108, 112, web (file) server 114 and/or web (application) server 116 may function as the system, devices, or components described herein.

The environment 100 may also include a database 118. The database 118 may reside in a variety of locations. By way of example, database 118 may reside on a storage medium local to (and/or resident in) one or more of the computers 104, 108, 112, 114, 116. Alternatively, it may be remote from any or all of the computers 104, 108, 112, 114, 116, and in communication (e.g., via the network 110) with one or more of these. The database 118 may reside in a Storage-Area Network (SAN) familiar to those skilled in the art. Similarly, any necessary files for performing the functions attributed to the computers 104, 108, 112, 114, 116 may be stored locally on the respective computer and/or remotely, as appropriate. The database 118 may be a relational database, such as Oracle 20i®, that is adapted to store, update, and retrieve data in response to Structured Query Language (SQL) formatted commands.

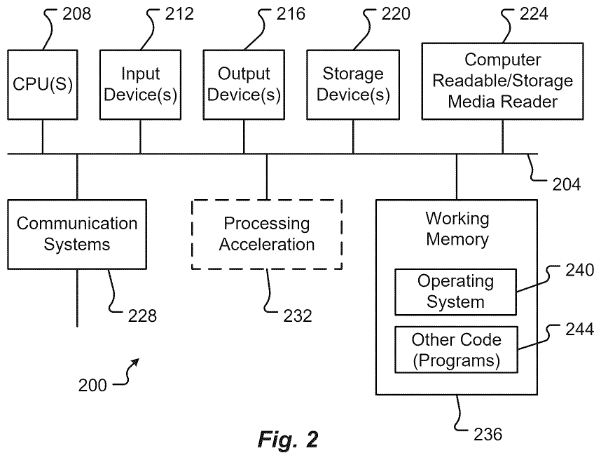

FIG. 2 is a block diagram illustrating elements of an exemplary computing device in which embodiments of the present disclosure may be implemented. More specifically, this example illustrates one embodiment of a computer system 200 upon which the servers, user computers, computing devices, or other systems or components described above may be deployed or executed. The computer system 200 is shown comprising hardware elements that may be electrically coupled via a bus 204. The hardware elements may include one or more Central Processing Units (CPUs) 208; one or more input devices 212 (e.g., a mouse, a keyboard, etc.); and one or more output devices 216 (e.g., a display device, a printer, etc.). The computer system 200 may also include one or more storage devices 220. By way of example, storage device(s) 220 may be disk drives, optical storage devices, solid-state storage devices such as a Random-Access Memory (RAM) and/or a Read-Only Memory (ROM), which can be programmable, flash-updateable and/or the like.

The computer system 200 may additionally include a computer-readable storage media reader 224; a communications system 228 (e.g., a modem, a network card (wireless or wired), an infra-red communication device, etc.); and working memory 236, which may include RAM and ROM devices as described above. The computer system 200 may also include a processing acceleration unit 232, which can include a Digital Signal Processor (DSP), a special-purpose processor, and/or the like.

The computer-readable storage media reader 224 can further be connected to a computer-readable storage medium, together (and, optionally, in combination with storage device(s) 220) comprehensively representing remote, local, fixed, and/or removable storage devices plus storage media for temporarily and/or more permanently containing computer-readable information. The communications system 228 may permit data to be exchanged with a network and/or any other computer described above with respect to the computer environments described herein. Moreover, as disclosed herein, the term “storage medium” may represent one or more devices for storing data, including ROM, RAM, magnetic RAM, core memory, magnetic disk storage mediums, optical storage mediums, flash memory devices and/or other machine-readable mediums for storing information.

The computer system 200 may also comprise software elements, shown as being currently located within a working memory 236, including an operating system 240 and/or other code 244. It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed.

Examples of the processors 208 as described herein may include, but are not limited to, at least one of Qualcomm® Snapdragon® 800 and 801, Qualcomm® Snapdragon® 620 and 615 with 4G LTE Integration and 64-bit computing, Apple® A 7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® 15-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AM D® K averi processors, Texas Instruments® Jacinto C6000™ automotive infotainment processors, Texas Instruments® OMAP™ automotive-grade mobile processors, ARM® Cortex™-M processors, ARM® Cortex-A and ARM 926EJ-S™ processors, other industry-equivalent processors, and may perform computational functions using any known or future-developed standard, instruction set, libraries, and/or architecture.

Any one or more servers and/or other computing devices as described above can be adapted to develop and execute software applications dedicated to specific domains, i.e., domain expert software applications. Embodiments of the present disclosure are directed to facilitating access and use of existing domain expert software applications through the use of Artificial Intelligence (AI) to analyze, distill and index source code of expert software systems and expose information through new and evolving fully dynamic natural language interfaces. M ore specifically, embodiments described herein are directed to dynamically building an interface to existing expert systems through recursive summarization of expert system logic (potentially decades of it) into condensed AI-generated summaries from the unlabeled source code. These summaries, describing the different parts of the expert system, can then be used to generate new means of interacting with the existing system without having to fully understand or write the interface. Thus, for example, embodiments of the present disclosure can be used to take an ancient system written in obsolete programming language with a dated interface and limited ability to expand and build a way of interfacing with it more dynamically and directly via human language queries. These processes can be applied to both old and new expert systems and can lead to emerging new use case patterns not envisaged by existing architects of said systems.

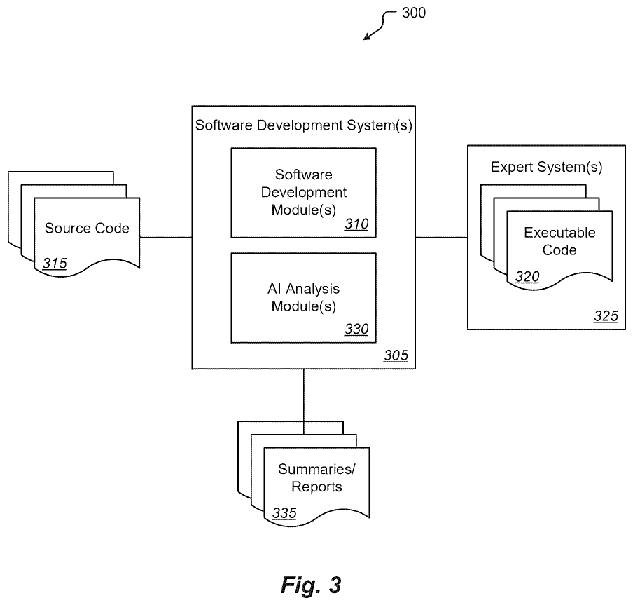

FIG. 3 is a block diagram illustrating an exemplary environment 300 in which embodiments of the present disclosure can be implemented. As illustrated in this example, the environment 300 can comprise a software development system 305 comprising a set of software development modules 310. As known in the art, the software development modules 310 can comprise various tools and/or other components to allow developers to define, edit, and manage source code for various software applications and/or components thereof. The software development modules 310 can also comprise one or more compilers. As known in the art, the compiler(s) can compile various source code files 315 into executable code for execution on servers and/or computing devices such as may be used to implement one or more expert systems, for example.

Commonly with expert systems, the number of source code files 315 can be very large. If a need arises to utilize these components, human expert knowledge must be relied upon. However, such as with legacy expert systems that may have been in use for a long period of time, insight into the functions of the source code 315 can be lost with time do to a loss of human expert knowledge, for example. In such cases, it becomes extremely difficult, if not impossible, to thoroughly analyze the source code 315, which may be unlabeled, in order to utilize the functions available therein. Embodiments described herein are directed to leveraging AI to analyze the source code files 315 of the expert system to provide summaries of the functions therein which can then be used to access and utilize those functions.

Accordingly, and as illustrated here, the software development system(s) 305 can further comprise one or more AI modules 330. Generally speaking and as will be described further below, embodiments of the present disclosure include a two-phase process. In the first phase, referred to herein as the analysis phase, the AI module(s) 330 can use an iterative process of AI-based summarization and code interpretation to condense, analyze and index the source code 315 into semantic definitions describing each component and/or sub-component defined in the source code 315 as well as its functionality and applicability for various tasks.

Subsequently, in the second phase referred to herein as the execution phase, through a combination of semantic matching and AI-based interpretation of end user queries, correct components defined in the source code 315 can be identified and activated to formulate a comprehensive response to the user queries. These responses can be combined and reported to the end user through AI-based summarization 335 of discrete component responses. Parameter mapping to source code 315 components can be performed through AI-based mapping of user query to component summarization 335 generated as part of the initial analysis. For example, the AI analysis module(s) can leverages LL M-type AI systems for summarization 335, code interpretation, user interaction and loose coupling with the expert system applications via a dynamic interface.

An end-result of this analysis can be a natural language interface into an existing expert system, leveraging sets of capabilities of target products, i.e., applications within the expert system(s), while introducing completely new dynamic interface, reducing training and onboarding time, and overhead for introducing new functionality. For example, these summaries can be accessed, searched, and utilized based on a human language query or prompt processed by the AI used by the software development system 305. Thus, embodiments described herein can allow extraction of expert knowledge and can provide an interface to most software systems in a universal manner through annotation of system components and subsequent use of these annotations 425 to provide fully dynamic interaction in natural language.

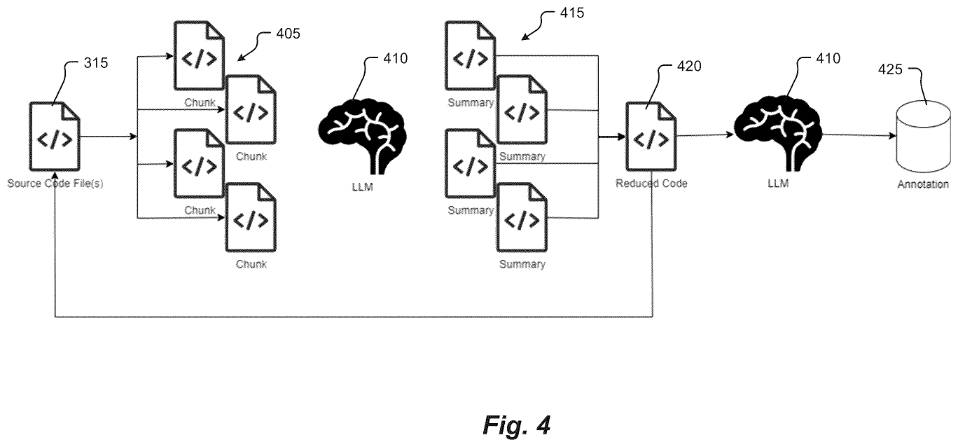

FIG. 4 is a diagram conceptually illustrating an analysis phase of applying artificial intelligence for interaction with expert software applications according to one embodiment of the present disclosure. This analysis can be performed offline as a preparation stage. As illustrated in this example, source code 315 of components and sub-components of expert system applications can be divided into overlapping chunks 405. These chunks 405 can be summarized utilizing Large Language Model (LLM) AI 410 into pseudocode summaries 415 and reassembled into a reduced set 420 of code. The process can iterate until summarization results in a pre-defined size of technical logic summaries 415. These summaries 415 can then be used, along with LLM AI 410, to generate annotated component descriptions 425, both technical as well as functional and semantic, that can be persisted.

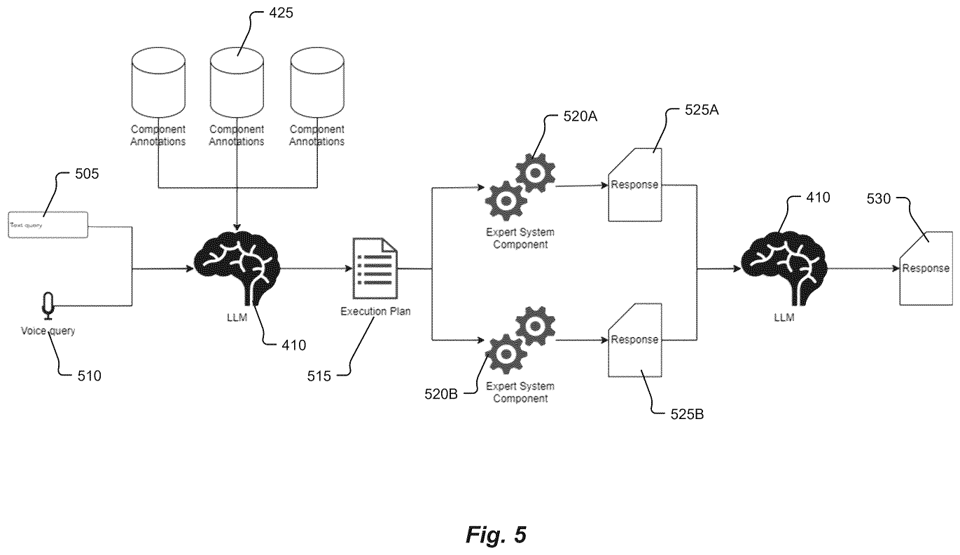

FIG. 5 is a diagram conceptually illustrating an execution phase of applying artificial intelligence for interaction with expert software applications according to one embodiment of the present disclosure. Generally speaking, the execution phase can comprise use of annotations 425 from the analysis phase for selection and execution of the components to build a query response. Execution can be triggered by end user natural language input, e.g., a text prompt 505 and/or voice query 510. Based on this input, the system can apply LLM AI 410 to dynamically generate an execution plan 515 and execute a set of subcomponents 520A-520B of the expert system, generate summaries 525A-525B of their results, and present the summarized results as a response 530 to the user query.

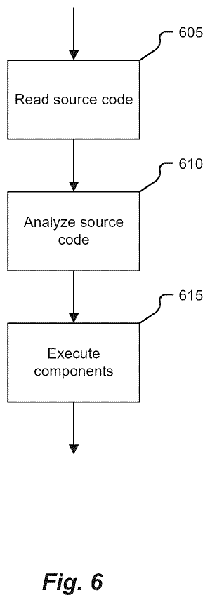

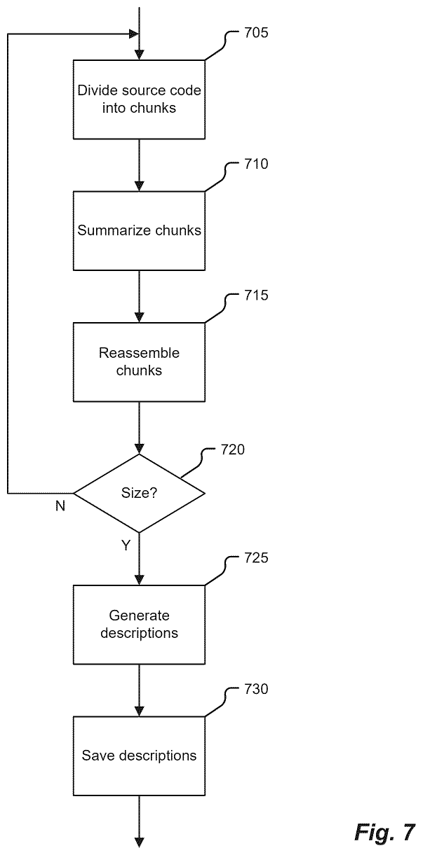

FIG. 6 is a flowchart illustrating an exemplary process for applying artificial intelligence for interaction with expert software applications according to one embodiment of the present disclosure. As illustrated in this example, the process can comprise two main steps. First, selected source code 315 of the expert system application(s) can be read 605 analyzed 610. This can be performed periodically, on demand, and/or upon the occurrence of a predefined condition or event. Additional details of an exemplary analysis process will be described below with reference to FIG. 7.

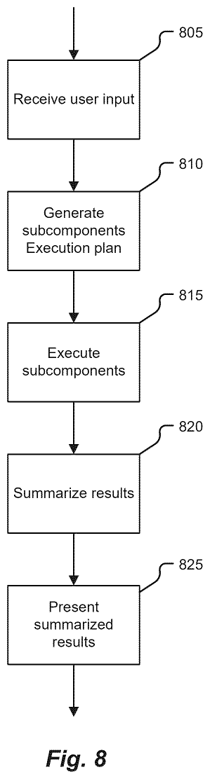

At some point in time, the execution phase can be initiated and performed. The execution phase can be initiated by a user query expressed in natural language. The query and annotated components from the analysis phase can be used to dynamically plan and execute 615 a set of subcomponents 520A-520B of the expert system, summarize their results, and present the summarized results as a response 530 to the user query. Additional details of an exemplary execution process will be described below with reference to FIG. 8.

FIG. 7 is a flowchart illustrating additional details of an exemplary analysis process according to one embodiment of the present disclosure. As illustrated in this example, the process can begin with dividing 705 source code 315 of components and subcomponents 520A-520B of an expert system application into overlapping chunks 405. These chunks 405 can be summarized 710 utilizing LLM AI 410 into pseudocode summaries 415 and reassembled 715 into a reduced set 420 of code. A determination 720 can then be made as to whether a predefined size set of summaries 415 is available. The process can iterate until summarization results in the predefined size technical logic summary is reached. The process can iterate until summarization results in a pre-defined size of technical logic summaries 415. These summaries 415 can then be used, along with LLM AI 410, to generate 725 annotated component descriptions 425, both technical as well as functional and semantic, that can be saved 730.

FIG. 8 is a flowchart illustrating additional details of an exemplary execution process according to one embodiment of the present disclosure. As illustrated in this example, the process can begin with receiving 805 a user's natural language input, e.g., a query for software components. This query can comprise, for example, a text or voice prompt. Using LLM AI 410, the natural language input, and the annotated summaries 335 from the analysis phase, a set of subcomponents 520A-520B can be dynamically planned 810. The planned 810 subcomponents 520A-520B can be executed 815 and results of the execution 815 can be summarized 820 using LLM AI 410. The summarized 820 results can then be presented 825 as a response 530 to the received user query, e.g., as search results identifying components and/or subcomponents 520A-520B that satisfy the query.

Thus, for example, embodiments of the present disclosure can be used to take an ancient system written in obsolete programming language with a dated interface and limited ability to expand and build a way of interfacing with it more dynamically and directly via human language queries. These processes can be applied to both old and new expert systems and can lead to emerging new use case patterns not envisaged by existing architects of said systems.

The present disclosure, in various aspects, embodiments, and/or configurations, includes components, methods, processes, systems, and/or apparatus substantially as depicted and described herein, including various aspects, embodiments, configurations embodiments, sub-combinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method for developing and executing software applications, the method comprising:
reading, by a processor of a software development system, source code of an expert system application;
analyzing, by the processor of the software development system, the source code using a generative Artificial Intelligence (AI), wherein results of the analyzing of the read source code comprises a set of annotated component descriptions of components and subcomponents of expert system application; and
executing, by the processor of the software development system, a selected set of the components and subcomponents of the expert system application based on a query regarding the expert system application and the set of annotated component descriptions of components and subcomponents of expert system application.

2. The method of claim 1, wherein the generative AI comprises a Large Language Model (LLM).

3. The method of claim 1, wherein analyzing the source code comprises:
dividing the source code of the components and subcomponents of the expert system application into a set of overlapping chunks;
summarizing each chunk of the set of overlapping chunks into a pseudocode summary using the generative AI;
reassembling the set of overlapping chunks into a reduced set of code;
determining whether a predefined size set of summaries is available; and
in response to determining the predefined size set of summaries is not yet available, iterating the dividing the source code of the components and subcomponents of the expert system application into the set of overlapping chunks, summarizing each chunk of the set of overlapping chunks into a pseudocode summary using the generative AI, reassembling the set of overlapping chunks into a reduced set of code, and determining whether a predefined size set of summaries is available until a determination is made that the predefined size set of summaries is available.

4. The method of claim 3, further comprising, in response to determining the predefined size set of summaries is available:
generating an annotated component description for each component and subcomponent of the expert system application based on the set of summaries using the generative AI; and
saving the annotated component description for each component and subcomponent of the expert system application.

5. The method of claim 4, wherein executing the selected set of the components and subcomponents of the expert system application comprises:
receiving the query regarding the expert system application;
generating a subcomponent execution plan based on the received query and the saved annotated component descriptions using the generative AI;
executing one or more components or subcomponents of the expert system application based on the generated subcomponent execution plan;
summarizing results of executing the one or more components or subcomponents of the expert system application using the generative AI; and
presenting the summarized results of executing the one or more components or subcomponents of the expert system application.

6. The method of claim 5, wherein the query regarding the expert system application comprises a natural language text prompt.

7. The method of claim 5, wherein the query regarding the expert system application comprises a natural language voice prompt.

8. A system comprising:
a processor; and
a memory coupled with and readable by the processor and storing therein a set of instructions which, when executed by the processor, causes the processor to:
read source code of an expert system application;
analyze the source code using a generative Artificial Intelligence (AI), wherein results of the analyzing of the read source code comprises a set of annotated component descriptions of components and subcomponents of expert system application; and
execute a selected set of the components and subcomponents of the expert system application based on a query regarding the expert system application and the set of annotated component descriptions of components and subcomponents of expert system application.

9. The system of claim 8, wherein the generative AI comprises a Large Language Model (LLM).

10. The system of claim 8, wherein analyzing the source code comprises:
dividing the source code of the components and subcomponents of the expert system application into a set of overlapping chunks;
summarizing each chunk of the set of overlapping chunks into a pseudocode summary using the generative AI;
reassembling the set of overlapping chunks into a reduced set of code;
determining whether a predefined size set of summaries is available; and
in response to determining the predefined size set of summaries is not yet available, iterating the dividing the source code of the components and subcomponents of the expert system application into the set of overlapping chunks, summarizing each chunk of the set of overlapping chunks into a pseudocode summary using the generative AI, reassembling the set of overlapping chunks into a reduced set of code, and determining whether a predefined size set of summaries is available until a determination is made that the predefined size set of summaries is available.

11. The system of claim 10, wherein in response to determining the predefined size set of summaries is available, the instructions further cause the processor to:
generate an annotated component description for each component and subcomponent of the expert system application based on the set of summaries using the generative AI; and
save the annotated component description for each component and subcomponent of the expert system application.

12. The system of claim 11, wherein executing the selected set of the components and subcomponents of the expert system application comprises:
receiving the query regarding the expert system application;
generating a subcomponent execution plan based on the received query and the saved annotated component descriptions using the generative AI;
executing one or more components or subcomponents of the expert system application based on the generated subcomponent execution plan;
summarizing results of executing the one or more components or subcomponents of the expert system application using the generative AI; and
presenting the summarized results of executing the one or more components or subcomponents of the expert system application.

13. The system of claim 12, wherein the query regarding the expert system application comprises a natural language text prompt.

14. The system of claim 12, wherein the query regarding the expert system application comprises a natural language voice prompt.

15. A non-transitory, computer-readable medium comprising a set of instructions stored therein which, when executed by a processor, causes the processor to:
read source code of an expert system application;
analyze the source code using a generative Artificial Intelligence (AI), wherein results of the analyzing of the read source code comprises a set of annotated component descriptions of components and subcomponents of expert system application; and
execute a selected set of the components and subcomponents of the expert system application based on a query regarding the expert system application and the set of annotated component descriptions of components and subcomponents of expert system application.

16. The system of claim 15, wherein the generative AI comprises a Large Language Model (LLM).

17. The system of claim 15, wherein analyzing the source code comprises:
dividing the source code of the components and subcomponents of the expert system application into a set of overlapping chunks;
summarizing each chunk of the set of overlapping chunks into a pseudocode summary using the generative AI;
reassembling the set of overlapping chunks into a reduced set of code;
determining whether a predefined size set of summaries is available; and
in response to determining the predefined size set of summaries is not yet available, iterating the dividing the source code of the components and subcomponents of the expert system application into the set of overlapping chunks, summarizing each chunk of the set of overlapping chunks into a pseudocode summary using the generative AI, reassembling the set of overlapping chunks into a reduced set of code, and determining whether a predefined size set of summaries is available until a determination is made that the predefined size set of summaries is available.

18. The system of claim 17, wherein in response to determining the predefined size set of summaries is available, the instructions further cause the processor to:
generate an annotated component description for each component and subcomponent of the expert system application based on the set of summaries using the generative AI; and
save the annotated component description for each component and subcomponent of the expert system application.

19. The system of claim 18, wherein executing the selected set of the components and subcomponents of the expert system application comprises:
receiving the query regarding the expert system application;
generating a subcomponent execution plan based on the received query and the saved annotated component descriptions using the generative AI;
executing one or more components or subcomponents of the expert system application based on the generated subcomponent execution plan;
summarizing results of executing the one or more components or subcomponents of the expert system application using the generative AI; and
presenting the summarized results of executing the one or more components or subcomponents of the expert system application.

20. The system of claim 19, wherein the query regarding the expert system application comprises at least one of a natural language text prompt or a natural language voice prompt.
